(19) United States
(12) Patent Application Publication
(10) Pub. No.: US 2003/0027740 A1
(43) Pub. Date: Feb. 6, 2003

(54) Laundry detergent and cleaning product tablets with improved disintegration properties

(76) Inventors: Manfred Weuthen, Langenfeld (DE); Ditmar Kischkel, Monheim (DE)

Correspondence Address: COGNIS CORPORATION, 2500 RENAISSANCE BLVD., SUITE 200, GULPH MILLS, PA, 19406

(21) Appl. No.: 10/122,482

(22) Filed: Apr. 12, 2002

(30) Foreign Application Priority Data
Apr. 12, 2001 (DE) 101 18 270.8

(51) Int. Cl. C11D 17/00

(52) U.S. Cl. 510/447; 510/421; 510/424; 510/470

(57) ABSTRACT

The present invention relates to laundry detergent and cleaning product tablets which are distinguished both by high hardness, and thus stability in transit and on handling, and excellent disintegration properties. This advantageous profile of properties is achieved by the tablets comprising fatty alcohol alkoxylates and alkyl polyglycosides in the ratio defined by the invention.

The present invention is situated in the field of compact shaped bodies which have wash-active and detersive properties. The invention relates in particular to shaped laundry detergent and cleaning product bodies used for washing textiles in a domestic washing machine and referred to for short as laundry detergent tablets.

Laundry detergent and cleaning product tablets are widely described in the prior art and are enjoying increasing popularity among users on account of the ease of metering. Tableted laundry detergents and cleaning products have a number of advantages over their powder-form counterparts: they are easier to meter and handle and their compact structure gives advantages in storage and transport. In the patent literature as well, therefore, laundry detergent and cleaning product tablets have been comprehensively described. One problem which occurs again and again in connection with the use of wash-active and detersive tablets is the insufficient disintegration and dissolution rate of the tablets under service conditions. Since sufficiently stable tablets, i.e., dimensionally stable and fracture-resistant tablets, can be produced only by means of relatively high compressive pressures, there is severe compaction of the tablet constituents and, consequently, retarded disintegration of the tablet in the aqueous liquor, and thus excessively slow release of the active substances in the washing or cleaning operation. The retarded disintegration of the tablets has the further disadvantage that customary laundry detergent and cleaning product tablets cannot be rinsed in via the dispenser drawer of domestic washing machines, since the tablets do not break down with sufficient rapidity into secondary particles which are small enough to be rinsed out of the dispenser drawer into the washing drum.

To overcome the dichotomy between hardness, i.e., transport and handling stability, and ready disintegration of the tablets, many proposed solutions have been developed in the prior art. One approach, which is known in particular from pharmacy and has expanded into the field of laundry detergent and cleaning product tablets, is the incorporation of certain disintegration aids, which facilitate the ingress of water or which swell on ingress of water, and exert a disintegrating action by evolving gas or in some other form. Other proposed solutions from the patent literature describe the compression of premixes of specific particle sizes, the separation of individual ingredients from certain other ingredients, and the coating of individual ingredients or of the entire tablet with binders.

For instance, EP 0 522 766 A (Unilever) discloses tablets of a compacted, particulate laundry detergent composition comprising surfactants, builders and disintegration aids (based on cellulose, for example), at least some of the particles being coated with the disintegrant, which has both a binder effect and a disintegrating effect when the tablets are dissolved in water. This document also points to the general difficulty of producing tablets combining adequate stability with good solubility. The particle size in the mixture to be compressed is said in this case to be above 200 μm, the intention being that the upper and lower limits of the individual particle sizes differ from one another by not more than 700 μm.

Further documents which concern themselves with the production of laundry detergent tablets are EP 0 716 144 A (Unilever), which describes tablets having an external shell of water-soluble material, and EP 0 711 827 A (Unilever), where one ingredient is a citrate having a defined solubility.

The use of binders which may develop a disintegrating action (especially polyethylene glycol) is described in EP 0 711 828 A (Unilever), which describes laundry detergent tablets produced by compressing a particulate laundry detergent composition at temperatures between 28° C. and the melting point of the binder material, compression always taking place at below the melting temperature. The examples of that document reveal that the tablets produced in accordance with its teaching have higher fracture strengths if compression is carried out at elevated temperature.

Laundry detergent tablets in which individual ingredients are present separately from others are described, inter alia, in EP 0 481 793 A (Unilever) The laundry detergent tablets disclosed in that document comprise sodium percarbonate, which is spatially separate from all other components that might affect its stability.

The use of alkyl polyglycosides in laundry detergent tablets has already been disclosed in DE 19754289 (Henkel). There, a general description is given of the fact that addition of alkyl polyglycosides increases the solubility of tablets, especially in combination with high fracture strength. There is no restriction as to the use of particular surfactants, nor are particular proportions of the surfactants to one another specified.

It is an object of the present invention, accordingly, to provide laundry detergent and cleaning product tablets which unite the desired properties of high hardness and mechanical stability with favorable disintegration rates.

It has now been found that laundry detergent tablets of high hardness and yet an extremely high disintegration rate can be produced by producing the laundry detergent and cleaning product formulation using fatty alcohol alkoxylates and alkyl polyglycosides in the ratio defined by the invention.

The invention accordingly provides laundry detergent and cleaning product tablets comprising compacted particulate laundry detergent and cleaning product, comprising surfactants and also, where appropriate further laundry detergent and cleaning product ingredients, wherein the tablets comprise surfactants from the group consisting of fatty alcohol alkoxylates and alkyl polyglycosides in a ratio of from 10:1 to 1:10, preferably from 5:1 to 1:5, in particular from 2:1 to 1:2, based on the active substance content.

### Fatty Alcohol Alkoxylates

Typical examples of these compounds are fatty alcohol polyethylene glycol/polypropylene glycol ethers of the formula (I) and fatty alcohol polypropylene glycol/polyethylene glycol ethers of the formula (II).

### Fatty Alcohol Polyethylene Glycol/Polypropylene Glycol Ethers

It is preferred to use fatty alcohol polyethylene glycol/polypropylene glycol ethers of the formula (I)

R¹O (CH₂CH₂O)ₙ[CH₂ (CH₃) CHO]ₘH (I)

in which R¹ is an alkyl and/or alkylene radical having from 8 to 22 carbon atoms, n is a number from 1 to 40, preferably from 1 to 30, in particular from 1 to 15, and m is 0 or a number from 1 to 10.

### Fatty Alcohol Polypropylene Glycol/Polyethylene Glycol Ethers

Preferably, it is also possible to use fatty alcohol polypropylene glycol/polyethylene glycol ethers of formula (II)

R²O[CH₂ (CH₃) CHO]_{q} (CH₂CH₂O) ᵣH (II)

in which R² is an alkyl and/or alkylene radical having from 8 to 22 carbon atoms, q is a number from 1 to 5, and r is a number from 0 to 15.

In accordance with one preferred embodiment the tablets comprise fatty alcohol polyethylene glycol/polypropylene glycol ethers of the formula (I) in which R¹ is an aliphatic, saturated, straight-chain or branched alkyl radical having from 8 to 16 carbon atoms, n is a number from 1 to 10, and m is 0. These are adducts of from 1 to 10 mol of ethylene oxide with monofunctional fatty alcohols.

Preference is also given to using fatty alcohol alkoxylates of the formula (I) in which R¹ is an aliphatic, saturated, straight-chain or branched alkyl radical having from 8 to 16 carbon atoms, n is a number from 2 to 7, and m is a number from 3 to 7. These are adducts of monofunctional alcohols alkoxylated first with from 2 to 7 mol of ethylene oxide and then with from 3 to 7 mol of propylene oxide.

### Alkyl and/or Alkenyl Oligoglycosides

The laundry detergent and cleaning product tablets of the invention comprise alkyl and alkenyl oligoglycosides, referred to for short below as APGs. They customarily conform to the formula (III)

R³O[G]ₚ (III)

in which R³ is an alkyl and/or alkenyl radical having from 4 to 22 carbon atoms, G is a sugar radical having or 6 carbon atoms, and p stands for numbers from 1 to 10.

They may be obtained by the relevant processes of preparative organic chemistry. As representatives of the extensive literature, reference may be made here to the documents EP 0301298 Al and WO 90/03977. The alkyl and/or alkenyl oligoglycosides may derive from aldoses and/or ketoses having 5 or 6 carbon atoms, preferably from glucose. The preferred alkyl and/or alkenyl oligoglycosides are therefore alkyl and/or alkenyl oligoglucosides. The index p in the general formula (III) indicates the degree of oligomerization (DP), i.e., the distribution of monoglycosides and oligoglycosides, and stands for a number between 1 and 10. While p in a given compound must always be integral and in this case may adopt in particular the values p=1 to 6, p for a particular alkyl oligoglycoside is an analytically determined arithmetic variable which usually represents a fraction. Preference is given to using alkyl and/or alkenyl oligoglycosides having an average degree of oligomerization p of from 1.1 to 3.0. From a performance standpoint, preference is given to alkyl and/or alkenyl oligoglycosides whose degree of oligomerization is less than 1.7 and is in particular between 1.2 and 1.4.

The alkyl and/or alkenyl radical R³ may derive from primary alcohols having from 4 to 11, preferably from 8 to 10, carbon atoms. Typical examples are butanol, caproyl alcohol, caprylyl alcohol, capryl alcohol, and undecyl alcohol, and their technical-grade mixtures, as obtained, for example, in the hydrogenation of technical-grade fatty acid methyl esters or in the course of the hydrogenation of aldehydes from the Roelen oxo process. Preference is given to alkyl oligoglucosides of chain length C8-C10 (DP=1 to 3), which are obtained as the initial fraction during the distillative separation of technical-grade C8-C18 coconut fatty alcohol and may have an impurities fraction of less than 6% by weight of C12 alcohol, and also alkyl oligoglucosides based on technical-grade C9/11 oxo alcohols (DP=1 to 3). The alkyl and/or alkenyl radical R³ may also derive from primary alcohols having from 12 to 22, preferably from 12 to 14, carbon atoms. Typical examples are lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol, and their technical-grade mixtures, which may be obtained as described above. Preference is given to alkyl oligoglucosides based on hydrogenated C12/14 cocoyl alcohol with a DP of from 1 to 3.

In another embodiment the laundry detergent and cleaning products contain from 0.5 to 25% by weight, preferably from 1 to 15% by weight, in particular from 1 to 10% by weight, of alkyl polyglycosides, calculated as active substance based on the tablet.

Preference is further given to the laundry detergent and cleaning product tablets comprising further nonionic surfactants selected from the group formed by hydroxy mixed ethers, fatty acid lower alkyl esters, and amine oxides.

### Nonionic Surfactants

Typical examples of nonionic surfactants, besides those already described, are alkylphenol polyglycol ethers, fatty acid polyglycol esters, fatty acid amide polyglycol ethers, fatty amine polyglycol ethers, alkoxylated triglycerides, mixed ethers and mixed formals, fatty acid N-alkylglucamides, protein hydrolysates (especially plant products based on wheat), polyol fatty acid esters, sugar esters, sorbitan esters, and polysorbates. Where the nonionic surfactants contain polyglycol ether chains, these chains may have a conventional or, preferably, a narrowed homolog distribution (narrow range).

### Hydroxy Mixed Ethers

Preferred further nonionic surfactants are hydroxy mixed ethers of the formula (IV)

R⁴O[CH₂CHR⁵O]_{b}[CH₂CHR⁶O]_{y}CR⁷HCH (OH) R⁸ (IV)

in which R⁴ is alkyl and/or alkenyl radical having from 4 to 22 carbon atoms, R5 is hydrogen or a methyl or ethyl radical, R⁶ is hydrogen or a methyl or ethyl radical, R⁷ is hydrogen or an alkyl radical having from 2 to 18 carbon atoms, and R⁸ is an alkyl radical having from 2 to 22 carbon atoms. b stands for 0 or numbers from 1 to 40, y stands for 0 or numbers from 1 to 40, and the sum of b and y ought to be greater than or equal to 1.

Hydroxy mixed ethers may be ring opening products of either internal olefins (R⁷ other than hydrogen) or terminal olefins (R⁷ is hydrogen), the latter being preferred.

They are prepared by reacting 1,2-epoxyalkanes (R⁸CHOCHR⁷), in which R⁷ is hydrogen and R⁸ is an aliphatic saturated, straight-chain or branched alkyl radical having from 2 to 22, in particular from 6 to 16, carbon atoms, with alkoxylated alcohols.

Preference in the context of the invention is given to those hydroxy mixed ethers which derive from alkoxylates of monohydric alcohols of the formula R⁴-OH having from 4 to 18 carbon atoms, R⁴ being an aliphatic, saturated, straight-chain or branched alkyl radical, in particular one having from 6 to 16 carbon atoms, and R⁷ being hydrogen.

Examples of suitable straight-chain alcohols are 1-butanol, caproyl alcohol, enanthyl alcohol, caprylyl alcohol, pelargonyl alcohol, capryl alcohol, 1-undecanol, lauryl alcohol, 1-tridecanol, myristyl alcohol, 1-pentadecanol, palmityl alcohol, 1-heptadecanol, stearyl alcohol, 1-nonadecanol, arachidyl alcohol, 1-heneicosanol, behenyl alcohol, and their technical-grade mixtures, as are obtained in the high-pressure hydrogenation of technical-grade methyl esters based on fats and oils. Examples of branched alcohols of this kind are those known as oxo alcohols, which usually carry from 2 to 4 methyl group branches and are prepared by the oxo process, and those known as Guerbet alcohols, which are branched in position 2 with an alkyl group. Suitable Guerbet alcohols are 2-ethyl-hexanol, 2-butyloctanol, 2-hexyldecanol and/or 2-octyl-dodecanol.

The alcohols are used in the form of their alkoxylates, which are prepared by reacting the alcohols in any order with ethylene oxide, propylene oxide and/or butylene oxide in a known manner.

In one preferred embodiment, alkoxylates of alcohols formed by reaction with from 10 to 80 mol of ethylene oxide are used, R⁵, R⁶, and R⁷ being hydrogen and b+y being 1-80.

A further embodiment describes alkoxylates formed by reaction of alcohol with from 1 to 10 mol of propylene oxide (R⁵=methyl, b=1-10) and from 10 to 40 mol of ethylene oxide (R⁶=hydrogen, y=10-40) and alkoxylates formed by reaction with from 10 to 40 mol of ethylene oxide (R⁵=hydrogen, b=10-40) and from 1 to 10 mol of propylene oxide (R⁶=methyl, y=1-10), where R⁷ in each case is hydrogen.

Particularly suitable hydroxy mixed ethers of the formula (IV) are those in which R⁷ is hydrogen, R⁵ is a methyl radical, and R⁶ is hydrogen, which advantageously have been prepared by reacting alcohol with from 1 to 3 mol of propylene oxide (b=1-3) and then with from 10 to 25 mol of ethylene oxide (y=10-25).

### Alkoxylated Fatty Acid Lower Alkyl Esters

Suitable alkoxylated fatty acid lower alkyl esters are surfactants of the formula (V)

R¹²CO (OCH₂CHR⁹)ₛOR¹⁰ (V)

in which R¹²CO is a linear or branched, saturated and/or unsaturated acyl radical having from 6 to 22 carbon atoms, R⁹ is hydrogen or methyl, R¹⁰ is linear or branched alkyl radicals having from 1 to 4 carbon atoms, and s stands for numbers from 1 to 20. Typical examples are the formal insertion products of on average from 1 to 20 and preferably from 5 to 10 mol of ethylene oxide and/or propylene oxide into the methyl, ethyl, propyl, isopropyl, butyl, and tert-butyl esters of caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselinic acid, linoleic acid, linolenic acid, eleostearic acid, arachic acid, gadoleic acid, behenic acid, and erucic acid, and also their technical-grade mixtures.

The products are normally prepared by inserting the alkylene oxides into the carbonyl ester linkage in the presence of special catalysts, such as calcined hydrotalcite, for example.

Particular preference is given to insertion products of on average from 5 to 10 mol of ethylene oxide into the ester linkage of technical-grade coconut fatty acid methyl esters.

### Amine Oxides

As amine oxides it is possible to use compounds of the formula (VI) and/or (VII).

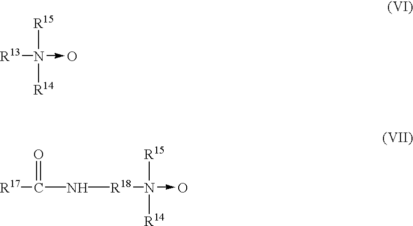

The preparation of the amine oxides of the formula (VI) involves starting from tertiary fatty amines containing at least one long alkyl radical and oxidizing them in the presence of hydrogen peroxide. In the amine oxides of the formula (VI) that are contemplated in the context of the invention, R¹³ is a linear or branched alkyl radical having from 6 to 22, preferably from 12 to 18, carbon atoms, and also R¹⁴ and R¹⁵ independently of one another are R¹³ or an optionally hydroxy-substituted alkyl radical having from 1 to 4 carbon atoms. It is preferred to use amine oxides of the formula (VI) in which R¹³ and R¹⁴ are C_{12/14} and/or C_{12/18} cocoalkyl radicals and R¹⁵ is a methyl or a hydroxyethyl radical. Likewise preferred are amine oxides of the formula (VI) in which R¹³ is a C_{12/14} and/or C_{12/18} cocoalkyl radical and R¹⁴ and R¹⁵ have the meaning of a methyl or hydroxyethyl radical.

Further suitable amine oxides are alkylamido-amine oxides of the formula (VII), in which the alkylamido radical R¹⁷CONH comes about through the reaction of linear or branched carboxylic acids, preferably having from 6 to 22, more preferably having from 12 to 18, carbon atoms, in particular of C_{12/14} and/or C_{12/18} fatty acids with amines. R¹⁸ represents a linear or branched alkylene group having from 2 to 6, preferably from 2 to 4, carbon atoms and R¹⁴ and R¹⁵ have the definition indicated in formula (VI).

### Anionic Surfactants

The laundry detergent and cleaning product tablets may further comprise anionic surfactants. Typical examples of anionic surfactants are soaps, alkylbenzenesulfonates, secondary alkanesulfonates, olefinsulfonates, alkyl ether sulfonates, glycerol ether sulfonates, α-methyl ester sulfonates, sulfo fatty acids, alkyl and/or alkenyl sulfates, alkyl ether sulfates, glycerol ether sulfates, hydroxy-mixed ether sulfates, fatty alcohol (ether) phosphates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acyl amino acids such as, for example, acyl lactylates, acyl tartrates, acyl glutamates and acyl aspartates, alkyl oligoglucoside sulfates, protein fatty acid condensates (especially plant products based on wheat), and alkyl (ether) phosphates. Where the anionic surfactants contain polyglycol ether chains, these chains may have a conventional or, preferably, a narrowed homolog distribution.

Preferred anionic surfactants are those selected from the group formed by alkyl and/or alkenyl sulfates, alkyl ether sulfates, alkylbenzenesulfonates, soaps, monoglyceride (ether) sulfates and alkanesulfonates, especially fatty alcohol sulfates, fatty alcohol ether sulfates, secondary alkanesulfonates, and linear alkylbenzenesulfonates.

### Alkyl and/or Alkenyl Sulfates

Alkyl and/or alkenyl sulfates, frequently also referred to as fatty alcohol sulfates, are the sulfation products of primary alcohols, conforming to the formula (VIII)

R¹⁹O—SO₃X (VIII)

in which R¹⁹ is a linear or branched, aliphatic alkyl and/or alkenyl radical having from 6 to 22, preferably from 12 to 18, carbon atoms, and X is an alkali metal and/or alkaline earth metal, ammonium, alkylammonium, alkanolammonium or glucammonium.

Typical examples of alkyl sulfates that may be used in the context of the invention are the sulfation products of caproyl alcohol, caprylyl alcohol, capryl alcohol, 2-ethylhexyl alcohol, lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, and erucyl alcohol, and also their technical-grade mixtures obtained by high-pressure hydrogenation of industrial methyl ester fractions or aldehydes from the Roelen oxo process. The sulfation products may be used preferably in the form of their alkali metal salts and in particular of their sodium salts. Particular preference is given to alkyl sulfates based on C_{16/18} tallow fatty alcohols or vegetable fatty alcohols of comparable carbon chain distribution in the form of their sodium salts.

### Alkyl Ether Sulfates

Alkyl ether sulfates (“ether sulfates”) constitute known anionic surfactants which are prepared industrially by SO₃ or chlorosulfonic acid (CSA) sulfation of fatty alcohol or oxo alcohol polyglycol ethers and subsequent neutralization. Ether sulfates suitable in the context of the invention are those which conform to the formula (IX)

R²⁰O—(CH₂CH₂O)ₐSO₃X (IX)

in which R²⁰ is a linear or branched alkyl and/or alkenyl radical having from 6 to 22 carbon atoms, a stands for numbers from 1 to 10, and X is an alkali metal and/or alkaline earth metal, ammonium, alkylammonium, alkanolammonium or glucammonium. Typical examples are the sulfates of adducts of on average from 1 to 10 and in particular from 2 to 5 mol of ethylene oxide with caproyl alcohol, caprylyl alcohol, 2-ethylhexyl alcohol, capryl alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, and brassidyl alcohol, and also their technical-grade mixtures in the form of their sodium and/or magnesium salts. The ether sulfates may have either a conventional or a narrowed homolog distribution. Particularly preferred is the use of ether sulfates based on adducts of on average from 2 to 3 mol of ethylene oxide with technical-grade C_{12/14} and/or C_{12/18} coconut fatty alcohol fractions in the form of their sodium and/or magnesium salts.

### Alkylbenzenesulfonates

Alkylbenzenesulfonates conform preferably to the formula (X)

R²¹—Ph—SO₃X (X)

in which R²¹ is a branched or, preferably, linear alkyl radical having from 10 to 18 carbon atoms, Ph is a phenyl radical, and X is an alkali metal and/or alkaline earth metal, ammonium, alkylammonium, alkanolammonium or glucammonium. Preference is given to using dodecylbenzenesulfonates, tetradecylbenzenesulfonates, hexadecylbenzenesulfonates, and their technical-grade mixtures in the form of the sodium salts.

### Soaps

By soaps, finally, are meant fatty acid salts of the formula (XI)

R²²CO—OX (XI)

in which R²²CO is a linear or branched, saturated or unsaturated acyl radical having from 6 to 22 and preferably from 12 to 18 carbon atoms, and X is alkali metal and/or alkaline earth metal, ammonium, alkylammonium or alkanolammonium. Typical examples are the sodium, potassium, magnesium, ammonium, and triethanolammonium salts of caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselinic acid, linoleic acid, linolenic acid, elaeostearic acid, arachic acid, gadoleic acid, behenic acid, and erucic acid, and also their technical-grade mixtures. Preference is given to using coconut or palm kernel fatty acid in the form of their sodium or potassium salts.

### Monoglyceride (Ether) Sulfates

Monoglyceride sulfates and monoglyceride ether sulfates constitute known anionic surfactants which may be obtained in accordance with the relevant methods of preparative organic chemistry. They are usually prepared starting from triglycerides, which immediately or following ethoxylation are transesterified to the monoglycerides and subsequently sulfated and neutralized. It is likewise possible to react the partial glycerides with suitable sulfating agents, preferably gaseous sulfur trioxide or chlorosulfonic acid [cf. EP 0561825 B1, EP 0561999 B1 (Henkel)]. The neutralized substances may, if desired, be subjected to ultrafiltration in order to reduce the electrolyte content to a desired level [DE 4204700 A1 (Henkel)]. Reviews of the chemistry of the monoglyceride sulfates have appeared, for example, by A. K. Biswas et al. in J. Am. Oil. Chem. Soc. 37, 171 (1960) and F. U, Ahmed J. Am. Oil. Chem. Soc. 67, 8 (1990). The monoglyceride (ether) sulfates for use in the context of the invention conform to the formula (XII)

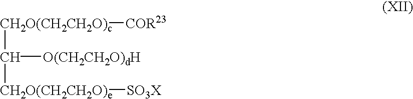

in which R²³CO is a linear or branched acyl radical having from 6 to 22 carbon atoms, c, d and e in total stand for 0 or for numbers from 1 to 30, preferably from 2 to 10, and X is an alkali metal or alkaline earth metal. Typical examples of monoglyceride (ether) sulfates suitable in the context of the invention are the reaction products of lauric monoglyceride, coconut fatty acid monoglyceride, palmitic monoglyceride, stearic monoglyceride, oleic monoglyceride and tallow fatty acid monoglyceride, and also their ethylene oxide adducts with sulfur trioxide or chlorosulfonic acid in the form of their sodium salts. It is preferred to use monoglyceride sulfates of the formula (XII) in which R²³CO is a linear acyl radical having from 8 to 18 carbon atoms.

### Alkanesulfonates

Alkanesulfonates can be divided into primary and secondary alkanesulfonates. By alkanesulfonates are meant compounds of the formula (XIII)

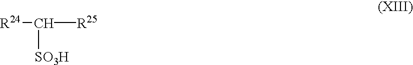

where in the case of primary alkanesulfonates R²⁴ is hydrogen and R²⁵ is an alkyl radical having not more than 50 carbon atoms. Preference is given to the secondary alkanesulfonates.

R²⁴ and R²⁵ are alkyl radicals, and R²⁴ and R²⁵ together should have not more than 50 carbon atoms.

### Cationic, Amphoteric or Zwitterionic Surfactants

In a preferred embodiment, the laundry detergent and cleaning product tablets of the invention comprise cationic and/or amphoteric or zwitterionic surfactants selected from the group formed by ester quats, alkyl betaines, alkylamido betaines, and imidazolinium betaines.

### Cationic Surfactants

Typical examples of cationic surfactants are tetraalkylammonium compounds, such as, for example, dimethyldistearylammonium chloride or Hydroxyethyl Hydroxycetyl Dimmonium Chloride (Dehyquart® E). The use of ester quats is especially preferred.

### Ester Quats

These comprise, for example, quaternized fatty acid triethanolamine ester salts of the formula (XIV)

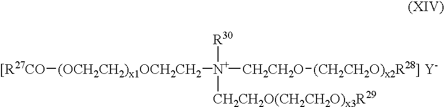

in which R²⁷CO is an acyl radical having from 6 to 22 carbon atoms, R²⁸ and R²⁹ independently of one another are hydrogen or R²⁷CO, R³⁰ is an alkyl radical having from 1 to 4 carbon atoms or a (CH₂CH₂O)ₓ₄H group, x1, x2 and x3 in total stand for 0 or numbers from 1 to 12, x4 stands for numbers from 1 to 12, and Y is halide, alkyl sulfate or alkyl phosphate. Typical examples of ester quats which may be used in the context of the invention are products based on caproic acid, caprylic acid, capric acid, lauric acid, myristic acid, palmitic acid, isostearic acid, stearic acid, oleic acid, elaidic acid, arachic acid, behenic acid, and erucic acid, and also their technical-grade mixtures as produced, for example, in the pressure cracking of natural fats and oils. Preference is given to using technical-grade C12/18 coconut fatty acids and especially partially hydrogenated C16/18 tallow and/or palm fatty acids and also C16/18 fatty acid cuts rich in elaidic acid. For preparing the quaternized esters, the fatty acids and the triethanolamine may be used in a molar ratio of from 1.1:1 to 3:1. In view of the performance properties of the ester quats, a ratio of from 1.2:1 to 2.2:1, preferably from 1.5:1 to 1.9:1, has proven particularly advantageous. The preferred ester quats constitute technical-grade mixtures of monoesters, diesters and triesters with an average degree of esterification of from 1.5 to 1.9 and derive from technical-grade C16/18 tallow and/or palm fatty acid (iodine number from 0 to 40). From a performance stand-point, quaternized fatty acid triethanolamine ester salts of the formula (XIV) have proven particularly advantageous in which R²⁷CO is an acyl radical having from 16 to 18 carbon atoms, R²⁸ is R²⁷CO, R²⁹ is hydrogen, R³⁰ is a methyl group, (x1+x2+x3) stands for 0, and Y is methyl sulfate.

Besides the quaternized fatty acid triethanolamine ester salts, further suitable ester quats include quaternized ester salts of fatty acids with diethanolalkylamines of the formula (XV)

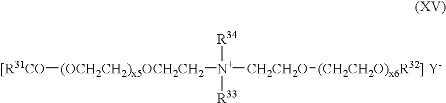

in which R³¹CO is an acyl radical having from 6 to 22 carbon atoms, R³² is hydrogen or R³¹CO, R³³ and R³⁴ independently of one another are alkyl radicals having from 1 to 4 carbon atoms, x5 and x6 in total stand for 0 or numbers from 1 to 12, and Y is halide, alkyl sulfate or alkyl phosphate.

As a further group of suitable ester quats, finally, mention may be made of the quaternized ester salts of fatty acids with 1,2-dihydroxypropyldialkylamines of the formula (XVI)

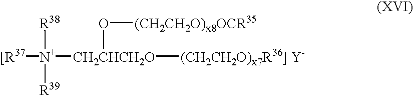

in which R³⁵CO is an acyl radical having from 6 to 22 carbon atoms, R³⁶ is hydrogen or R³⁵CO, R³⁷, R³⁸, and R³⁹ independently of one another are alkyl radicals having from 1 to 4 carbon atoms, x7 and x8 in total stand for 0 or numbers from 1 to 12, and Y is halide, alkyl sulfate or alkyl phosphate.

Finally, suitable ester quats further include substances in which the ester linkage has been replaced by an amide linkage and which preferably, based on diethylenetriamine, conform to the formula (XVII)

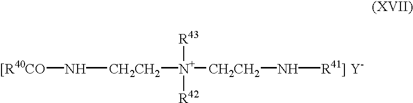

in which R⁴CO is an acyl radical having from 6 to 22 carbon atoms, R⁴¹ is hydrogen or R⁴⁰CO, R⁴² and R⁴³ independently of one another are alkyl radicals having from 1 to 4 carbon atoms, and Y is halide, alkyl sulfate or alkyl phosphate. Amide ester quats of this kind are available on the market under the name Incroquat® (Croda), for example.

### Amphotheric Surfactants

As amphoteric or zwitterionic surfactants the laundry detergent and cleaning product tablets may comprise alkyl betaines, alkylamido betaines, aminopropionates, aminoglycinates, imidazolinium betaines and/or sulfo betaines.

### Alkyl Betaines

Examples of suitable alkyl betaines are the carboxyalkylation products of secondary and especially tertiary amines which conform to the formula (XVIII)

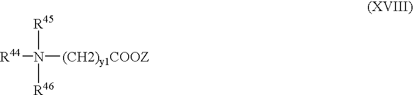

in which R⁴⁴ stands for alkyl and/or alkenyl radicals having from 6 to 22 carbon atoms, R⁴⁵ stands for hydrogen or alkyl radicals having from 1 to 4 carbon atoms, R⁴⁶ stands for alkyl radicals having from 1 to 4 carbon atoms, y1 stands for numbers from 1 to 6, and Z is an alkali metal and/or alkaline earth metal or ammonium. Typical examples are the carboxymethylation products of hexylmethylamine, hexyldimethylamine, octyldimethylamine, decyldimethylamine, dodecylmethylamine, dodecyldimethylamine, dodecylethylmethylamine, C12/14 cocoalkyldimethylamine, myristyldimethylamine, cetyldimethylamine, stearyldimethylamine, stearylethylmethylamine, oleyldimethylamine, C16/18 tallow alkyldimethylamine, and also their technical-grade mixtures.

### Alkylamido Betaines

Also suitable are carboxyalkylation products of amidoamines, which conform to the formula (XIX)

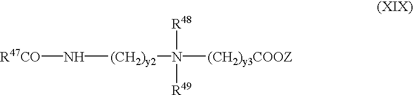

in which R⁴⁷CO is an aliphatic acyl radical having from 6 to 22 carbon atoms and 0 or from 1 to 3 double bonds, R⁴⁸ stands for hydrogen or alkyl radicals having 1 to 4 carbon atoms, R⁴⁹ stands for alkyl radicals having from 1 to 4 carbon atoms, y2 and y3 independently of one another stand for numbers from 1 to 6, and Z is an alkali metal and/or alkaline earth metal or ammonium. Typical examples are reaction products of fatty acids having from 6 to 22 carbon atoms, namely caproic acid, caprylic acid, capric acid, lauric acid, myristic acid, palmitic acid, palmoleic acid, stearic acid, isostearic acid, oleic acid, elaidic acid, petroselinic acid, linoleic acid, linolenic acid, eleostearic acid, arachic acid, gadoleic acid, behenic acid, and erucic acid, and also their technical-grade mixtures, with N,N-dimethylaminoethylamine, N,N-dimethylaminopropylamine, N,N-diethylaminoethylamine, and N,N-diethylaminopropylamine, these products being condensed with sodium chloroacetate. Preference is given to the use of a condensation product of C8/18 coconut fatty acid N,N-dimethylaminopropyl amide with sodium chloroacetate.

### Imidazolinium Betaines

Also suitable, furthermore, are imidazolinium betaines. These substances are also known substances, which may be obtained, for example, by cyclizing condensation of 1 or 2 mol of fatty acid with polyfunctional amines such as aminoethylethanolamine (AEEA) or diethylenetriamine, for example. The corresponding carboxyalkylation products are mixtures of different openchain betaines. Typical examples are condensation products of the abovementioned fatty acids with AEEA, preferably imidazolines based on lauric acid or again C12/14 coconut fatty acid, which are subsequently betainized with sodium chloroacetate.

### Disintegrants (Disintegration Aids)

The surfactant granules of the invention may comprise disintegrants. These are substances which are present in the surfactant granules in order to accelerate their breakdown when they are brought into contact with water. Overviews of this subject can be found, for example, in J. Pharm. Sci. 61 (1972) or Römpp Chemielexikon, 9th edition, volume 6, p. 4440. Viewed macroscopically, the disintegrants may be distributed homogeneously within the granules, but viewed microscopically the preparation process may result in the formation of zones of increased concentration. The preferred disintegrants include polysaccharides, such as natural starch and derivatives thereof (carboxymethylstarch, starch glycolates in the form of their alkali metal salts, agar, guar gum, pectins, etc.), celluloses and their derivatives (carboxymethylcellulose, microcrystalline cellulose), polyvinylpyrrolidone, Kollidon, alginic acid and its alkali metal salts (alginates), amorphous or else partly crystalline phyllosilicates (bentonites), polyurethanes, polyethylene glycols, and gas-generating systems. Further distintegrants that may be present in the context of the invention can be found, for example, in the documents WO 98/40462 (Rettenmaier), WO 98/55583 and WO 98/55590 (Unilever), and WO 98/40463, DE 19709991 and DE 19710254 (Henkel). The teaching of these specifications is expressly incorporated by reference.

In one preferred embodiment, laundry detergent and cleaning product tablets contain from 0.5 to 10% by weight, preferably from 1 to 7% by weight, and in particular from 2 to 6% by weight of a disintegration aid, based in each case on the tablet weight.

Preferred disintegrants used in the context of the present invention are cellulose-based distintegrants, so that preferred laundry detergent and cleaning product tablets contain a cellulose-based disintegrant of this kind in amounts of from 0.5 to 10% by weight, preferably from 1 to 7% by weight, and in particular from 2 to 6% by weight. Pure cellulose has the formal empirical composition (C₆H₁₀O₅)ₙ and, considered formally, is a β-1,4-polyacetal of cellobiose, which itself is constructed of two molecules of glucose. Suitable celluloses consist of from about 500 to 5 000 glucose units and, accordingly, have average molecular masses of from 50 000 to 500 000. Cellulose-based disintegrants which can be used also include, in the context of the present invention, cellulose derivatives obtainable from cellulose by polymer-analogous reactions. Such chemically modified celluloses include, for example, products of esterifications and etherifications in which hydroxy hydrogen atoms have been substituted. However, celluloses in which the hydroxyl groups have been replaced by functional groups not attached via an oxygen atom may also be used as cellulose derivatives. The group of the cellulose derivatives also embraces, for example, alkali metal celluloses, carboxymethylcellulose (CMC), cellulose esters and cellulose ethers, and aminocelluloses.

Said cellulose derivatives are preferably not used alone as cellulose-based disintegrants but instead are used in a mixture with cellulose. The cellulose derivative content of these mixtures is preferably less than 50% by weight, with particular preference less than 20% by weight, based on the cellulose-based disintegrant. A particularly preferred cellulose-based disintegrant used is pure cellulose, free from cellulose derivatives.

As a further cellulose-based disintegrant or as a constituent of this component it is possible to use microcrystalline cellulose. This microcrystalline cellulose is obtained by partial hydrolysis of celluloses under conditions which attack only the amorphous regions (approximately 30% of the total cellulose mass) of the celluloses and break them up completely but leave the crystalline regions (approximately 70%) intact. Subsequent deaggregation of the microfine celluloses resulting from the hydrolysis yields the microcrystalline celluloses, which have primary particle sizes of approximately 5 μm and may be compacted, for example, to granules having an average particle size of 200 μm.

### Auxiliaries and Additives in Laundry Detergent and Cleaning Product Tablets

The laundry detergent and cleaning product tablets may preferably comprise one or more further auxiliaries and additives from the group of builders, optical brighteners, enzymes, enzyme stabilizers, defoamers, codisintegrants, proteins and protein derivatives, small amounts of neutral filling salts, and also dyes and fragrances.

As builders it is possible, for example, to use zeolites. The finely crystalline, synthetic zeolite frequently used as a laundry detergent builder, containing bound water, is preferably zeolite A and/or P. An example of a particularly preferred zeolite P is zeolite MAP® (commercial product from Crosfield). Also suitable, however, are zeolite X and also mixtures of A, X and/or P and also Y. Also of particular interest is a cocrystallized sodium/potassium aluminum silicate comprising zeolite A and zeolite X, which is available commercially as VEGOBOND AX® (commercial product from Condea Augusta S.p.A.). The zeolite may be employed in the form of spray-dried powder or else as an undried (still wet from its preparation), stabilized suspension. Where the zeolite is used in suspension form, said suspension may include small additions of nonionic surfactants as stabilizers: for example, from 1 to 3% by weight, based on zeolite, of ethoxylated C₁₂-C₁₈ fatty alcohols having from 2 to 5 ethylene oxide groups, C₁₂-C₁₄ fatty alcohols having from 4 to 5 ethylene oxide groups or ethoxylated isotridecanols. Suitable zeolites have an average particle size of less than 10 μm (volume distribution; measurement method: Coulter counter) and contain preferably from 18 to 22% by weight, in particular from 20 to 22% by weight, of bound water.

Suitable substitutes or partial substitutes for phosphates and zeolites are crystalline, layered sodium silicates of the general formula NaMSiₓO₂ₓ₁·yH₂O, where M is sodium or hydrogen, x is a number from 1.9 to 4, y is a number from 0 to 20, and preferred values for x are 2, 3 or 4. Crystalline phyllosilicates of this kind are described, for example, in the European patent application EP 0164514 A1. Preferred crystalline phyllosilicates of the formula indicated are those in which M is sodium and x adopts the value 2 or 3. In particular, both β- and δ-sodium disilicates Na₂Si₂O₅.yH₂O are preferred, β-sodium disilicate, for example, being obtainable by the process described in the international patent application WO 91/08171. Further suitable phyllosilicates are known, for example, from the patent applications DE 2334899 A1, EP 0026529 A1 and DE 3526405 A1. Their usefulness is not restricted to a specific composition or structural formula. However, preference is given here to smectites, especially bentonites. Suitable phyllosilicates which belong to the group of the water-swellable smectites include, for example, those of the general formulae

(OH) ₄Si_{8-y}Al_{y} (MgₓAl₄₋ₓ) O₂₀ montmorillonite

(OH) ₄Si_{8-y}Al_{y} (Mg_{6-z}Li_{z}) O₂₀ hectorite

(OH) ₄Si_{8-y}Al_{y} (Mg_{6-z}Al_{z}) O₂₀ saponite

where x=0 to 4, y=0 to 2, z=0 to 6. Moreover, small amounts of iron may be incorporated into the crystal lattice of the phyllosilicates in accordance with the above formulae. Moreover, on the basis of their ion exchange properties, the phyllosilicates may contain hydrogen, alkali metal and/or alkaline earth metal ions, especially Na⁺ and Ca²⁺. The amount of water in hydrate form is generally in the range from 8 to 20% by weight and is dependent on the state of swelling and/or on the nature of processing. Phyllosilicates which can be used are known, for example, from U.S. Pat. No. 3,966,629, U.S. Pat. No. 4,062,647, EP 0026529 A1 and EP 0028432 A1. It is preferred to use phyllosilicates which owing to an alkali treatment are substantially free of calcium ions and strongly coloring iron ions.

The preferred builder substances also include amorphous sodium silicates having an Na₂O:SiO₂ modulus of from 1:2 to 1:3.3, preferably from 1:2 to 1:2.8, and in particular from 1:2 to 1:2.6, which are dissolution-retarded and have secondary washing properties. The retardation of dissolution relative to conventional amorphous sodium silicates may have been brought about in a variety of ways; for example, by surface treatment, compounding, compacting, or overdrying. In the context of this invention, the term “amorphous” also embraces “X-ray-amorphous”. This means that, in X-ray diffraction experiments, the silicates do not yield the sharp X-ray reflections typical of crystalline substances but instead yield at best one or more maxima of the scattered X-radiation, having a width of several degree units of the diffraction angle. However, good builder properties may result, even particularly good builder properties, if the silicate particles in electron diffraction experiments yield vague or even sharp diffraction maxima. The interpretation of this is that the products have microcrystalline regions with a size of from 10 to several hundred nm, values up to max. 50 nm and in particular up to max. 20 nm being preferred. So-called X-ray-amorphous silicates of this kind, which likewise possess retarded dissolution relative to the conventional waterglasses, are described, for example, in the German patent application DE 4400024 A1. Particular preference is given to compact amorphous silicates, compounded amorphous silicates, and overdried X-ray-amorphous silicates.

It is of course also possible to use the widely known phosphates as builder substances, provided such a use is not to be avoided on ecological grounds. Particularly suitable phosphates are the sodium salts of the orthophosphates, of the pyrophosphates and, in particular, of the tripolyphosphates. Their amount should generally be not more than 25% by weight, preferably not more than 20% by weight, based in each case on the finished composition. In certain cases it has been found that tripolyphosphates in particular, even in small amounts up to not more than 10% by weight, based on the finished composition, lead in combination with other builder substances to a synergistic improvement in the secondary detergency.

The builders are present in the laundry detergent and cleaning product tablets at from 0 to 70% by weight, preferably in amounts of from 10 to 60 and in particular from 20 to 40% by weight, based on the tablet.

Useful organic builder substances suitable as cobuilders are, for example, the polycarboxylic acids, which can be used in the form of their sodium salts, such as citric acid, adipic acid, succinic acid, glutaric acid, tartaric acid, sugar acids, amino carboxylic acids, nitrilotriacetic acid (NTA), provided such use is not objectionable on ecological grounds, and also mixtures of these. Preferred salts are the salts of the polycarboxylic acids such as citric acid, adipic acid, succinic acid, glutaric acid, tartaric acid, sugar acids, and mixtures thereof. The acids per se may also be used. In addition to their builder effect, the acids typically also possess the property of an acidifying component and thus also serve to establish a lower and milder pH of laundry detergents or cleaning products. In this context, mention may be made in particular of citric acid, succinic acid, glutaric acid, adipic acid, gluconic acid, and any desired mixtures thereof.

Further suitable organic builder substances are dextrins, examples being oligomers and polymers of carbohydrates, which may be obtained by partial hydrolysis of starches. The hydrolysis may be conducted by customary processes, examples being acid-catalyzed or enzyme-catalyzed processes. The hydrolysis products preferably have average molar masses in the range from 400 to 500 000. Preference is given here to a polysaccharide having a dextrose equivalent (DE) in the range from 0.5 to 40, in particular from 2 to 30, DE being a common measure of the reducing effect of a polysaccharide in comparison to dextrose, which possesses a DE of 100. It is possible to use both maltodextrins having a DE of between 3 and 20 and dry glucose syrups having a DE of between 20 and 37, and also so-called yellow dextrins and white dextrins having higher molar masses, in the range from 2 000 to 30 000. One preferred dextrin is described in the British patent application GB 9419091 A1. The oxidized derivatives of such dextrins comprise their products of reaction with oxidizing agents which are able to oxidize at least one alcohol function of the saccharide ring to the carboxylic acid function. Oxidized dextrins of this kind, and processes for preparing them, are known, for example, from the European patent applications EP 0232202 A1, EP 0427349 A1, EP 0472042 A1 and EP 0542496 A1 and from the international patent applications WO 92/18542, WO 93/08251, WO 93/16110, WO 94/28030, WO 95/07303, WO 95/12619 and WO 95/20608. Likewise suitable is an oxidized oligosaccharide in accordance with the German patent application DE 19600018 A1. A product oxidized at C₆ of the saccharide ring may be particularly advantageous.

Further suitable cobuilders are oxydisuccinates and other derivatives of disuccinates, preferably ethylenediamine disuccinate. Particular preference is given in this context as well to glycerol disuccinates and glycerol trisuccinates, as described for example in the U.S. patents U.S. Pat. No. 4,524,009, U.S. Pat. No. 4,639,325, in the European patent application EP 0150930 A1 and in the Japanese patent application JP 93/339896. Suitable use amounts in formulations containing zeolite and/or silicate are from 3 to 15% by weight.

Further organic cobuilders which can be used are, for example, acetylated hydroxycarboxylic acids and/or their salts, which may also be present, where appropriate, in lactone form and which contain at least 4 carbon atoms and at least one hydroxyl group and also not more than two acid groups. Cobuilders of this kind are described, for example, in the international patent application WO 95/20029.

Suitable polymeric polycarboxylates are, for example, the sodium salts of polyacrylic acid or of polymethacrylic acid, examples being those having a relative molecular mass of from 800 to 150 000 (based on acid and in each case measured against polystyrenesulfonic acid). Particularly suitable copolymeric polycarboxylates are those of acrylic acid with methacrylic acid and of acrylic acid or methacrylic acid with maleic acid. Copolymers of acrylic acid with maleic acid, containing from 50 to 90% by weight acrylic acid and from 50 to 10% by weight maleic acid, have proven particularly suitable. Their relative molecular mass, based on free acids, is generally from 5 000 to 200 000, preferably from 10 000 to 120 000, and in particular from 50 000 to 100 000 (measured in each case against polystyrenesulfonic acid). The (co)polymeric polycarboxylates may be used either as powders or in the form of an aqueous solution, in which case preference is given to aqueous solutions with a strength of from 20 to 55% by weight. Granular polymers are generally admixed subsequently to one or more base granules. Particular preference is also given to biodegradable polymers made up of more than two different monomer units, examples being those in accordance with DE 4300772 A1, containing as monomers salts of acrylic acid and of maleic acid and also vinyl alcohol and/or vinyl alcohol derivatives, or those in accordance with DE 4221381 C2, containing as monomers salts of acrylic acid and of 2-alkylallylsulfonic acid and also sugar derivatives. Preferred also as copolymers are those which are described in the German patent applications DE 4303320 A1 and DE 4417734 A1 and which as monomers comprise preferably acrolein and acrylic acid/acrylic acid salts or acrolein and vinyl acetate. Further preferred builder substances include polymeric amino dicarboxylic acids, their salts or their precursors. Particular preference is given to polyaspartic acids and their salts and derivatives.

Further suitable builder substances are polyacetals, which may be obtained by reacting dialdehydes with polyolcarboxylic acids having from 5 to 7 carbon atoms and at least 3 hydroxyl groups, as described for example in the European patent application EP 0280223 A1. Preferred polyacetals are obtained from dialdehydes such as glyoxal, glutaraldehyde, terephthalaldehyde and mixtures thereof and from polyolcarboxylic acids such as gluconic acid and/or glucoheptonic acid.

In addition, the compositions may also comprise components which have a positive influence on the ease with which oil and fat are washed off from textiles. The preferred oil- and fat-detaching components include, for example, nonionic cellulose ethers such as methylcellulose and methylhydroxypropylcellulose having a methoxy group content of from 15 to 30% by weight and a hydroxypropoxy group content of from 1 to 15% by weight, based in each case on the nonionic cellulose ether, and also the prior art polymers of phthalic acid and/or of terephthalic acid and/or of derivatives thereof, especially polymers of ethylene terephthalates and/or polyethylene glycol terephthalates, or anionically and/or nonionically modified derivatives thereof. Of these, particular preference is given to the sulfonated derivatives of the phthalic acid polymers and of the terephthalic acid polymers.

Further suitable ingredients are water-soluble inorganic salts such as bicarbonates, carbonates, amorphous silicates, normal waterglasses which have no outstanding builder properties, or mixtures thereof; use is made in particular of alkali metal carbonate and/or amorphous alkali metal silicate, especially sodium silicate having a molar ratio Na₂O:SiO₂ of from 1:1 to 1:4.5, preferably from 1:2 to 1:3.5. The amount of sodium carbonate in the final formulations is preferably up to 40% by weight, advantageously between 2 and 35% by weight. The amount of sodium silicate (without special builder properties) in the compositions is generally up to 10% by weight and preferably between 1 and 8% by weight.

Among the compounds used as bleaches which yield H₂O₂ in water, particular importance is possessed by sodium perborate tetrahydrate and sodium perborate monohydrate. Further bleaches which may be used are, for example, sodium percarbonate, peroxypyrophosphates, citrate perhydrates, and H₂O₂-donating peracidic salts or peracids, such as perbenzoates, peroxophthalates, diperazelaic acid, phthaloiminoperoxy acid or diperdodecanedioic acid. The bleach content is preferably from 0 to 35% by weight and in particular up to 30% by weight, use being made advantageously of perborate monohydrate or percarbonate.

Bleach activators which may be used are compounds which under perhydrolysis conditions give rise to aliphatic peroxocarboxylic acids having preferably from 1 to 10 carbon atoms, in particular from 2 to 4 carbon atoms, and/or unsubstituted or substituted perbenzoic acid. Suitable substances are those which carry 0-acyl and/or N-acyl groups of the stated number of carbon atoms, and/or substituted or unsubstituted benzoyl groups. Preference is given to polyacylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially tetraacetylglycoluril (TAGU), N-acyl imides, especially N-nonanoylsuccinimide (NOSI), acylated phenolsulfonates, especially n-nonanoyl- or isononanoyloxybenzenesulfonate (n- or iso-NOBS), carboxylic anhydrides, especially phthalic anhydride, acylated polyhydric alcohols, especially triacetin, ethylene glycol diacetate, 2,5-diacetoxy-2,5-dihydrofuran, and the enol esters known from the German patent applications DE 19616693 A1 and DE 19616767 A1, and also acetylated sorbitol and mannitol and/or mixtures thereof (SORMAN) described in the European patent application EP 0525239 A1, acylated sugar derivatives, especially pentaacetylglucose (PAG), pentaacetylfructose, tetraacetylxylose and octaacetyllactose, and also acetylated, optionally N-alkylated glucamine and gluconolactone, and/or N-acylated lactams, an example being N-benzoyl caprolactam, which are known from the international patent applications WO 94/27970, WO 94/28012, WO 94/28103, WO 95/00626, WO 95/14759 and WO 95/17498. The hydrophilically substituted acyl acetals known from the German patent application DE 19616769 A1 and the acyl lactams described in the German patent application DE 19616770 and also in the international patent application WO 95/14075 are likewise used with preference. It is also possible to use the combinations of conventional bleach activators known from the German patent application DE 4443177 A1. Bleach activators of this kind are present in the customary quantity range, preferably in amounts of from 1% by weight to 10% by weight, in particular from 2% by weight to 8% by weight, based on overall composition. In addition to the abovementioned conventional bleach activators, or instead of them, it is also possible for the bleach-boosting transition metal salts and/or transition metal complexes and/or sulfone imines known from the European patents EP 0446982 B1 and EP 0453003 B1 to be present as so-called bleaching catalysts. The transition metal compounds in question include in particular those manganese, iron, cobalt, ruthenium or molybdenum salen complexes known from the German patent application DE 19529905 A1, and their N-analog compounds known from the German patent application DE 19620267 A1; the manganese, iron, cobalt, ruthenium or molybdenum carbonyl complexes known from the German patent application DE 19536082 A1; the manganese, iron, cobalt, ruthenium, molybdenum, titanium, vanadium and copper complexes with nitrogen-containing tripod ligands that are described in the German patent application DE 196 05 688 A1; the cobalt, iron, copper and ruthenium amine complexes known from the German patent application DE 19620411 A1; the manganese, copper and cobalt complexes described in the German patent application DE 4416438 A1; the cobalt complexes described in the European patent application EP 0272030 A1; the manganese complexes known from the European patent application EP 0693550 A1; the manganese, iron, cobalt and copper complexes known from the European patent EP 0392592 A1; and/or the manganese complexes described in the European patent EP 0443651 B1 or in the European patent applications EP 0458397 A1, EP 0458398 A1, EP 0549271 A1, EP 0549272 A1, EP 0544490 A1 and EP 0544519 A1. Combinations of bleach activators and transition metal bleaching catalysts are known, for example, from the German patent application DE 19613103 A1 and from the international patent application WO 95/27775. Bleach-boosting transition metal complexes, especially those with the central atoms Mn, Fe, Co, Cu, Mo, V, Ti and/or Ru, are employed in customary amounts, preferably in an amount of up to 1% by weight, in particular from 0.0025% by weight to 0.25% by weight, and with particular preference from 0.01% by weight to 0.1% by weight, based in each case on the tablet.

Particularly suitable enzymes include those from the class of the hydrolases, such as the proteases, esterases, lipases or lipolytic enzymes, amylases, cellulases or other glycosyl hydrolases, and mixtures of the stated enzymes. All of these hydrolases contribute in the wash to removing stains, such as proteinaceous, fatty or starchy stains, and instances of graying. Cellulases and other glycosyl hydrolases may, by removing pilling and microfibrils, make a contribution to color retention and to enhancing the softness of the textile. For bleaching and/or for inhibiting dye transfer it is also possible to use oxidoreductases. Especially suitable active enzymatic substances are those obtained from bacterial strains or fungi, such as Bacillus subtilis, Bacillus licheniformis, Streptomyces griseus, and Humicola insolens. It is preferred to use proteases of the subtilisin type, and especially proteases obtained from Bacillus lentus. Of particular interest in this context are enzyme mixtures, examples being those of protease and amylase or protease and lipase or lipolytic enzymes, or protease and cellulase, or of cellulase and lipase or lipolytic enzymes, or of protease, amylase and lipase or lipolytic enzymes, or protease, lipase or lipolytic enzymes and cellulase, but especially mixtures containing protease and/or lipase, or mixtures containing lipolytic enzymes. Examples of such lipolytic enzymes are the known cutinases. Peroxidases or oxidases have also proven suitable in some cases. The suitable amylases include, in particular, α-amylases, isoamylases, pullulanases, and pectinases. Cellulases used are preferably cellobiohydrolases, endoglucanases and β-glucosidases, also referred to as cellobiases, and mixtures of these. Since the different cellulase types differ in their CMCase and Avicelase activities, the desired activities may be established by means of targeted mixtures of the cellulases.

The enzymes may be adsorbed on carrier substances and/or embedded in coating substances in order to protect them against premature decomposition. The fraction of the enzymes, enzyme mixtures or enzyme granules may be, for example, from about 0.1 to 5% by weight, preferably from 0.1 to about 2% by weight.

In addition to the monofunctional and polyfunctional alcohols, the compositions may comprise further enzyme stabilizers. For example, from 0.5 to 1% by weight of sodium formate may be used. Also possible is the use of proteases stabilized with soluble calcium salts, with a calcium content of preferably about 1.2% by weight, based on the enzyme. Besides calcium salts, magnesium salts also serve as stabilizers. However, it is particularly advantageous to employ boron compounds, examples being boric acid, boron oxide, borax and other alkali metal borates such as the salts of orthoboric acid (H₃BO₃), of metaboric acid (HBO₂), and of pyroboric acid (tetraboric acid, H₂B₄O₇)

Graying inhibitors (antiredeposition agents) have the function of keeping the soil detached from the fiber in suspension in the liquor and so preventing the reattachment (redeposition) of the soil. Suitable for this purpose are water-soluble colloids, usually organic in nature, examples being the water-soluble salts of polymeric carboxylic acids, glue, gelatin, salts of ether carboxylic acids or ether sulfonic acids of starch or of cellulose, or salts of acidic sulfuric esters of cellulose or of starch. Water-soluble polyamides containing acidic groups are also suitable for this purpose. Furthermore, use may be made of soluble starch preparations and starch products other than those mentioned above, examples being degraded starch, aldehyde starches, etc. Polyvinylpyrrolidone as well can be used. However, it is preferred to use celluose ethers, such as carboxymethylcellulose (Na salt), methylcellulose, hydroxyalkylcellulose, and mixed ethers, such as methylhydroxyethylcellulose, methylhydroxypropylcellulose, methylcarboxymethylcellulose and mixtures thereof, and also polyvinylpyrrolidone, for example, in amounts of from 0.1 to 5% by weight, based on the tablet.

As optical brighteners the compositions may comprise derivatives of diaminostilbenedisulfonic acid and/or alkali metal salts thereof. Suitable, for example, are salts of 4,4′-bis(2-anilino-4-morpholino-1,3,5-triazinyl-6-amino)stilbene-2,2′-disulfonic acid or compounds of similar structure which instead of the morpholino group carry a diethanolamino group, a methylamino group, an anilino group, or a 2-methoxyethylamino group. It is possible for brighteners of the substituted diphenylstyryl type to be present, examples being the alkali metal salts of 4,4′-bis(2-sulfostyryl)biphenyl, 4,4′-bis(4-chloro-3-sulfostyryl)-biphenyl or 4-(4-chlorostyryl)-4′-(2-sulfostyryl)biphenyl. Mixtures of the aforementioned brighteners may also be used. Uniformly white granules are obtained if, in addition to the customary brighteners in customary amounts, examples being between 0.1 and 0.5% by weight, preferably between 0.1 and 0.3% by weight, the compositions also include small amounts, examples being from 10⁻⁶ to 10⁻³% by weight, preferably around 10⁻⁵% by weight, of a blue dye. One particularly preferred dye is TINOLUX® (commercial product from Ciba-Geigy).

Suitable dirt-repelling polymers (soil repellents) include those substances which preferably contain ethylene terephthalate and/or polyethylene glycol terephthalate groups, it being possible for the molar ratio of ethylene terephthalate to polyethylene glycol terephthalate to be situated within the range from 50:50 to 90:10. The molecular weight of the linking polyethylene glycol units is situated in particular in the range from 750 to 5 000, i.e., the degree of ethoxylation of the polymers containing polyethylene glycol groups can be from about 15 to 100. The polymers feature an average molecular weight of about 5 000 to 200 000 and may have a block structure, though preferably have a random structure. Preferred polymers are those having ethylene terephthalate/polyethylene glycol terephthalate molar ratios of from about 65:35 to about 90:10, preferably from about 70:30 to 80:20.

Preference is also given to those polymers which have linking polyethylene glycol units with a molecular weight of from 750 to 5 000, preferably from 1 000 to about 3 000, and with a molecular weight of the polymer of from about 10 000 to about 50 000. Examples of commercial polymers are the products MILEASE® T (ICI) or REPELOTEX® SRP 3 (Rhône-Poulenc).

As defoamers it is possible to use waxlike compounds. “Waxlike” compounds are those whose melting point at atmospheric pressure is more than 25° C. (room temperature), preferably more than 50° C., and in particular more than 70° C. The waxlike defoamer substances are virtually insoluble in water; that is, at 20° C. they have a solubility in 100 g of water of below 0.1% by weight. In principle, any of the waxlike defoamer substances known from the prior art may be included. Examples of suitable waxlike compounds are bisamides, fatty alcohols, fatty acids, carboxylic acid esters of monohydric and polyhydric alcohols, and also paraffin waxes, or mixtures thereof. An alternative possibility is of course to use the silicone compounds which are known for this purpose.

Suitable paraffin waxes generally constitute a complex substance mixture without a defined melting point. The mixture is normally characterized by determining its melting range using differential thermal analysis (DTA), as described in The Analyst 87 (1962), 420, and/or its solidification point. The solidification point is the temperature at which the paraffin, by slow cooling, undergoes transition from the liquid to the solid state. Paraffins which are completely liquid at room temperature, i.e., those having a solidification point below 25° C., cannot be used in accordance with the invention. It is possible to use, for example, the paraffin wax mixtures known from EP 0309931 A1, made up for example of from 26% by weight to 49% by weight of microcrystalline paraffin wax having a solidification point of from 62° C. to 90°0 C., from 20% by weight to 49% by weight of hard paraffin with a solidification point of from 42° C. to 56° C., and from 2% by weight to 25% by weight of soft paraffin having a solidification point of from 35° C. to 40° C. It is preferred to use paraffins or paraffin mixtures which solidify in the range from 30° C. to 90° C. It needs to be borne in mind here that even paraffin wax mixtures which appear solid at room temperature may include various fractions of liquid paraffin. In the case of the paraffin waxes suitable for use in accordance with the invention, this liquid fraction is as low as possible and is preferably absent entirely. Accordingly, particularly preferred paraffin wax mixtures have a liquid fraction at 30° C. of less than 10% by weight, in particular from 2% by weight to 5% by weight, a liquid fraction at 40° C. of less than 30% by weight, preferably from 5% by weight to 25% by weight, and in particular from 5% by weight to 15% by weight, a liquid fraction at 60° C. of from 30% by weight to 60% by weight, in particular from 40% by weight to 55% by weight, a liquid fraction at 80° C. of from 80% by weight to 100% by weight, and a liquid fraction at 90° C. of 100% by weight. In the case of particularly preferred paraffin wax mixtures, the temperature at which a liquid fraction of 100% by weight of the paraffin wax is attained is still below 85° C., in particular at from 75° C. to 82° C. The paraffin waxes may comprise petrolatum, microcrystalline waxes, and hydrogenated or partially hydrogenated paraffin waxes.

Appropriate bisamide defoamers are those deriving from saturated fatty acids having from 12 to 22, preferably from 14 to 18 carbon atoms, and from alkylenediamines having from 2 to 7 carbon atoms. Suitable fatty acids are lauric, myristic, stearic, arachic and behenic acid and mixtures thereof, such as are obtainable from natural fats and/or hydrogenated oils, such as tallow or hydrogenated palm oil. Examples of suitable diamines are ethylenediamine, 1,3-propylenediamine, tetramethylenediamine, pentamethylenediamine, hexamethylenediamine, p-phenylenediamine, and tolylenediamine. Preferred diamines are ethylenediamine and hexamethylenediamine. Particularly preferred bisamides are bismyristoylethylenediamine, bispalmitoylethylenediamine, bisstearoylethylenediamine, and mixtures thereof, and also the corresponding derivatives of hexamethylenediamine.

Suitable carboxylic ester defoamers derive from carboxylic acids having from 12 to 28 carbon atoms. The esters in question particularly include those of behenic acid, stearic acid, hydroxystearic acid, oleic acid, palmitic acid, myristic acid and/or lauric acid. The alcohol moiety of the carboxylic ester comprises a monohydric or polyhydric alcohol having from 1 to 28 carbon atoms in the hydrocarbon chain. Examples of suitable alcohols are behenyl alcohol, arachidyl alcohol, cocoyl alcohol, 12-hydroxystearyl alcohol, oleyl alcohol, and lauryl alcohol, and also ethylene glycol, glycerol, polyvinyl alcohol, sucrose, erythritol, pentaerythritol, sorbitan and/or sorbitol. Preferred esters are those of ethylene glycol, glycerol, and sorbitan, the acid moiety of the ester being selected in particular from behenic acid, stearic acid, oleic acid, palmitic acid or myristic acid. Suitable esters of polyhydric alcohols are, for example, xylitol monopalmitate, pentaerythritol monostearate, glycerol monostearate, ethylene glycol monostearate, and sorbitan monostearate, sorbitan palmitate, sorbitan monolaurate, sorbitan dilaurate, sorbitan distearate, sorbitan dibehenate, sorbitan dioleate, and also mixed tallow alkyl sorbitan monoesters and diesters. Glycerol esters which can be used are the mono-, di- or triesters of glycerol and the carboxylic acids mentioned, with the monoesters or diesters being preferred. Glycerol monostearate, glycerol monooleate, glycerol monopalmitate, glycerol monobehenate, and glycerol distearate are examples thereof. Examples of suitable natural ester defoamers are beeswax, which consists principally of the esters CH₃ (CH₂)₂₄COO (CH₂)₂₇CH₃ and CH₃(CH₂)₂₆COO (CH₂) ₂₅CH₃, and carnauba wax, which is a mixture of carnaubic acid alkyl esters, often in combination with small fractions of free carnaubic acid, further long-chain acids, high molecular mass alcohols and hydrocarbons.

Suitable carboxylic acids are particularly behenic acid, stearic acid, oleic acid, palmitic acid, myristic acid, and lauric acid, and also mixtures thereof, such as are obtainable from natural fats and/or optionally hydrogenated oils, such as tallow or hydrogenated palm oil. Preference is given to saturated fatty acids having from 12 to 22, in particular from 18 to 22, carbon atoms.

Suitable fatty alcohols as further defoamer compounds are the hydrogenated products of the fatty acids described.

Furthermore, dialkyl ethers may additionally be present as defoamers. The ethers may be asymmetrical or else symmetrical in composition, i.e., contain two identical or different alkyl chains, preferably with from 8 to 18 carbon atoms. Typical examples are di-n-octyl ether, diisooctyl ether and di-n-stearyl ether; particularly suitable are dialkyl ethers having a melting point of more than 25° C., in particular more than 40° C.

Further suitable defoamer compounds are fatty ketones, which may be obtained by the relevant methods of preparative organic chemistry. They are prepared, for example, starting from carboxylic acid magnesium salts, which are pyrolyzed at temperatures above 300° C. with elimination of carbon dioxide and water, in accordance for example with the German laid-open specification 2553900. Suitable fatty ketones are those prepared by pyrolyzing the magnesium salts of lauric acid, myristic acid, palmitic acid, palmitoleic acid, stearic acid, oleic acid, elaidic acid, petroselinic acid, arachic acid, gadoleic acid, behenic acid or erucic acid.

Further suitable defoamers are fatty acid polyethylene glycol esters, which are obtained preferably by homogeneous base-catalyzed addition reaction of ethylene oxide with fatty acids. In particular, the addition reaction of ethylene oxide with the fatty acids takes place in the presence of alkanolamine catalysts. The use of alkanolamines, especially triethanolamine, leads to extremely selective ethoxylation of the fatty acids, especially where the aim is to prepare compounds with low degrees of ethoxylation. Within the group of the fatty acid polyethylene glycol esters, preference is given to those having a melting point of more than 25° C., in particular more than 40° C.

Within the group of the waxlike defoamers, particular preference is given to using the above-described paraffin waxes as sole waxlike defoamers or in a mixture with one of the other waxlike defoamers, the fraction of the paraffin waxes in the mixture accounting preferably for more than 50% by weight, based on the waxlike defoamer mixture. Where appropriate, the paraffin waxes may have been applied to carriers. Suitable carrier materials include all known inorganic and/or organic carrier materials. Examples of typical inorganic carrier materials are alkali metal carbonates, aluminosilicates, water-soluble phyllosilicates, alkali metal silicates, alkali metal sulfates, an example being sodium sulfate, and alkali metal phosphates. The alkali metal silicates preferably comprise a compound having an alkali metal oxide to SiO₂ molar ratio of from 1:1.5 to 1:3.5. The use of such silicates results in especially good particle properties; in particular, high abrasion stability and yet high dissolution rate in water. The aluminosilicates referred to as carrier materials include in particular the zeolites, examples being zeolite NaA and NaX. The compounds referred to as water-soluble phyllosilicates include, for example, amorphous or crystalline waterglass. It is also possible to use silicates which are in commerce under the designation AEROSIL® or SIPERNAT®. As organic carrier materials, suitable examples include film-forming polymers, examples being polyvinyl alcohols, polyvinylpyrrolidones, poly (meth)acrylates, polycarboxylates, cellulose derivatives, and starch. Cellulose ethers that may be used are, in particular, alkali metal carboxymethylcellulose, methylcellulose, ethylcellulose, hydroxyethylcellulose, and what are known as cellulose mixed ethers, examples being methylhydroxyethylcellulose and methylhydroxypropylcellulose, and also mixtures thereof. Particularly suitable mixtures are composed of sodium carboxymethylcellulose and methylcellulose, the carboxymethylcellulose usually having a degree of substitution of from 0.5 to 0.8 carboxymethyl groups per anhydroglucose unit and the methylcellulose having a degree of substitution of from 1.2 to 2 methyl groups per anhydroglucose unit. The mixtures preferably comprise alkali metal carboxymethylcellulose and nonionic cellulose ethers in weight proportions of from 80:20 to 40:60, in particular from 75:25 to 50:50. Another suitable carrier is natural starch, which is composed of amylose and amylopectin. Natural starch is starch such as is available as an extract from natural sources, for example, from rice, potatoes, corn, and wheat. Natural starch is a commercially customary product and as such is readily available. As carrier materials it is possible to use one or more of the compounds mentioned above, selected in particular from the group of the alkali metal carbonates, alkali metal sulfates, alkali metal phosphates, zeolites, water-soluble phyllosilicates, alkali metal silicates, polycarboxylates, cellulose ethers, polyacrylate/polymethacrylate, and starch. Particularly suitable mixtures are those of alkali metal carbonates, especially sodium carbonate, alkali metal silicates, especially sodium silicate, alkali metal sulfates, especially sodium sulfate, and zeolites.

Suitable silicones are customary organopolysiloxanes which may contain finely divided silica, which in turn may also have been silanized. Such organopolysiloxanes are described, for example, in the European patent application EP 0496510 A1. Particularly preferred polydiorganosiloxanes are those which are known from the prior art. It is also possible, however, to use siloxane-crosslinked compounds known to the skilled worker as siloxane resins. As a general rule, the polydiorganosiloxanes include finely divided silica, which may also have been silanized. Particularly suitable are silica-containing dimethylpolysiloxanes. Advantageously, the polydiorganosiloxanes have a Brookfield viscosity at 25° C. in the range from 5 000 mPas to 30 000 mPas, in particular from 15 000 to 25 000 mPas. The silicones are preferably applied to carrier materials. Suitable carrier materials have already been described in connection with the paraffins. The carrier materials are generally present in amounts of from 40 to 90% by weight, preferably in amounts of from 45 to 75% by weight, based on defoamer.

Tablets may further comprise codisintegrants, such as polyvinylpyrrolidone, Kollidon, alginic acid and its alkali metal salts, amorphous or else partly crystalline phyllosilicates (bentonites), polyurethanes, polyethylene glycols, and gas generating systems.

It is also possible for proteins and protein derivatives to be present which considerably enhance the dissolution of the surfactant mixtures of the invention. Express reference is made here to the unpublished application DE 19956802, whose disclosure content is also made part of the disclosure content of the present invention.

Suitable protein components include preferably protein hydrolyzates and also their condensation products with fatty acids, and to a lesser extent also protein hydrolyzate esters and quaternized protein fatty acid condensates. Protein hydrolyzates are degradation products of animal or vegetable proteins, examples being collagen, elastin or keratin and, preferably, almond protein and potato protein, and also, in particular, wheat, rice, and soya protein which are cleaved by acidic, alkaline and/or enzymatic hydrolysis and then have an average molecular weight in the range from 600 to 4000, preferably from 2000 to 3500. Although in the absence of a hydrophobic radical protein hydrolyzates are not surfactants in the conventional sense, they are widely used in the formulation of surface-active compositions, owing to their dispersing properties. Overviews on the preparation and use of protein hydrolyzates have appeared, for example, from G. Schuster and A. Domsch in Seifen Öle Fette Wachse 108, 177 (1982) and Cosm. Toil. 99, 63 (1984), from H. W. Steisslinger in Parf. Kosm. 72, 556 (1991), and F. Aurich et al. in Tens. Surf. Def. 29, 389 (1992). Preference is given to using plant protein hydrolyzates based on wheat gluten or rice protein, whose preparation is described in the two German patents DE 19502167 C1 and DE 19502168 C1 (Henkel). From the protein hydrolyzates it is possible, by condensation with C₆-C₂₂ fatty acids, preferably C₁₂-C₁₈ fatty acids, to prepare anionic surfactants, referred to as protein fatty acid condensates, whose properties are comparable with those of soaps. It is preferred to use condensates of said hydrolyzates with caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselinic acid, linoleic acid, linolenic acid, eleostearic acid, arachic acid, gadoleic acid, behenic acid, and erucic acid.

As perfume oils and/or fragrances it is possible to use certain odorant compounds, examples being the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate, and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial, and bourgeonal; the ketones include, for example, the ionones, α-isomethylionone and methyl cedryl ketone; the alcohols include anethole, citronellol, eugenol, geraniol, linalool, phenylethyl alcohol and terpineol; and the hydrocarbons include primarily the terpenes such as limonene and pinene. Preference, however, is given to the use of mixtures of different odorants, which together produce an appealing fragrance note. Such perfume oils may also contain natural odorant mixtures, such as are obtainable from plant sources, examples being pine oil, citrus oil, jasmine oil, patchouli oil, rose oil or ylang-ylang oil. Likewise suitable are muscatel, sage oil, camomile oil, clove oil, balm oil, mint oil, cinnamon leaf oil, lime blossom oil, juniperberry oil, vetiver oil, olibanum oil, galbanum oil, and labdanum oil, and also orange blossom oil, neroli oil, orangepeel oil, and sandalwood oil. The fragrances may be incorporated directly into the compositions of the invention; alternatively, it may be advantageous to apply the fragrances to carriers which intensify the adhesion of the perfume on the laundry and, by means of slower fragrance release, ensure long-lasting fragrance of the textiles. Materials which have become established as such carriers are, for example, cyclodextrins, it being possible in addition for the cyclodextrin-perfume complexes to be further coated with other auxiliaries.

If desired, the final formulations may further comprise inorganic salts as fillers and standardizers, such as sodium sulfate, for example, which is present preferably in amounts of from 0 to 20%, in particular from 1 to 12%, by weight based on the tablet.

### Production of the Laundry Detergent and Cleaning Product Tablet

The tablets are generally produced by tableting or press-agglomeration. The particulate press-agglomerates obtained may either be used directly as laundry detergents or may be aftertreated and/or processed beforehand in accordance with customary methods. The customary aftertreatments include, for example, powdering with finely divided ingredients of laundry detergents or cleaning products, thereby generally bringing about a further increase in the bulk density. Another preferred aftertreatment, however, is the procedure in accordance with the German patent applications 19524287 A1 and 19547457 A1, in which dustlike or at least finely divided ingredients (the so-called fine fractions) are adhesively bonded to the particulate end process products produced in accordance with the invention, which act as a core, so as to give compositions which contain these so-called fine fractions as an outer shell. Advantageously, this takes place in turn by means of a melt agglomeration operation. As regards the melt agglomeration of fine fractions, express reference is made to the disclosure in the German patent applications 19524287 A1 and 19547457 A1. In the preferred embodiment of the invention, the solid laundry detergents are in tablet form, these tablets preferably having rounded corners and edges for reasons in particular associated with storage and transit. The base area of these tablets may, for example, be circular or rectangular. Multilayer tablets, especially tablets having 2 or 3 layers, which may also be differently colored, are particularly preferred. Blue, green, white, pink, and combinations of these colors are especially preferred here. The tablets may also include compressed and uncompressed portions. Tablets having a particularly advantageous dissolution rate are obtained if the granular constituents prior to compression contain less than 20% by weight, preferably less than 10% by weight, of particles having a diameter outside of the range from 0.02 to 6 mm. Preference is given to a particle size distribution in the range from 0.05 to 2.0 and, with particular preference, from 0.2 to 1.0 mm.

Tablets may be manufactured in predetermined three-dimensional forms and predetermined sizes. Suitable three-dimensional forms include virtually all practicable designs; i.e., for example, bar forms, rod forms, cubes, blocks, and corresponding three-dimensional elements having planar side faces, and also, in particular, cylindrical designs with a circular or oval cross section. This last embodiment embraces the presentation form ranging from the tablet through to compact cylinders having a height-to-diameter ratio of more than 1.

The portioned compacts may in each case be designed as individual elements, separated from one another, corresponding to the predetermined dosage of the laundry detergent and/or cleaning product. Likewise, however, it is also possible to design compacts which combine a plurality of such mass units in one compact, with, in particular, predefined intended breakage points providing for easy separation of smaller, portioned units. For the use of textile detergents in machines of the type customary in Europe, with a horizontally arranged mechanism, it may be appropriate to design the portioned compacts as tablets, in cylinder or block form, preference being given to a diameter/height ratio in the range from about 0.5:2 to 2:0.5. Commercially customary hydraulic presses, eccentric presses or rotary presses are suitable apparatus in particular for producing compacts of this kind.

The three-dimensional form of another embodiment of tablets is adapted in its dimensions to the dispenser drawer of commercially customary domestic washing machines, so that the tablets can be metered directly, without a metering aid, into the dispenser drawer, where they dissolve during the rinsing-in operation. It is, however, also possible of course to use the laundry detergent tablets with a metering aid, without problems, and this is preferred in the context of the present invention.

Another preferred tablet which can be produced has a sheetlike or barlike structure with, in alternation, long, thick and short, thin segments, so that individual segments can be broken off from this “slab” at the intended breakage points, represented by the short, thin segments, and introduced into the machine. This principle of the laundry detergent “bar” may also be realized in other geometric forms, an example being vertical triangles connected to one another along only one of their sides.

### EXAMPLES

Surfactant granules were blended with pulverulent formulating components to prepare premixes which were compressed in a Kilian tableting press to give laundry detergent tablets each of 40 g. Empirically, the press pressure was set so as to give in each case three series of compacts, which differed only in terms of their hardness.

The tablets were then placed in airtight packaging and stored at 40° C. for 2 weeks. The compositions of the laundry detergent tablets can be seen from Table 1. Formulas 1 to 6 are inventive, formulas C1 to C4 serving for comparison. The surfactant content (detersive substances) was calculated as active substance.

In order to assess the dissolution characteristics, a tablet was placed on a wire frame standing in water (0° dH [German hardness], 25° C.). The tablet was completely surrounded by water. The disintegration time was measured as the time from immersion until complete dissolution. The disintegration times can likewise be seen from Table 1.

### Table 1

Table 1 depicts test formulas for laundry detergent tablets, and their solubilities. The amounts are in % by weight based on the tablet; in addition, the detersive substances (coconut alcohol sulfate sodium salt, LAS, fatty alcohol alkoxylate FAAO, C12/14 alkyl polyglucoside APG) were calculated based on active substance (*). The active substance describes the absolute amount of detersive substances. The formulas are made up to 100% using sodium sulfate (ad 100).

The tablets may contain up to 15% by weight of free or bound water, introduced, for example, through the use of builders or disintegrants.

The hardness of the tablets was measured by deforming the tablets until fracture occurred, and measuring the force acting on the side faces of the tablet and the maximum force withstood by the tablet.

TABLE 1

| Composition | 1 | 2 | 3 | 4 | 5 | 6 | C1 | C2 | C3 | C4 |
|---|---|---|---|---|---|---|---|---|---|---|
| Coconut | 3.2 | 3.2 | 3.2 | 6.3 | 6.3 | 6.3 | 3.2 | 6.3 | 3.2 | 3.2 |
| alcohol | (3*) | (3*) | (3*) | (6*) | (6*) | (6*) | (3*) | (6*) | (3*) | (3*) |
| sulfate | | | | | | | | | | |
| sodium salt | | | | | | | | | | |
| 1) | | | | | | | | | | |
| LAS 2) | 8.6 | 8.6 | 8.6 | 4.3 | 4.3 | 4.3 | 8.6 | 4.3 | 8.6 | 8.6 |
| | (6*) | (6*) | (6*) | (3*) | (3*) | (3*) | (6*) | (3*) | (6*) | (6*) |
| Fatty | 2 | 4 | 5 | 2 | 4 | 5 | 6 | 6 | 5.6 | 0.4 |
| alcohol | (2*) | (4*) | (5*) | (2*) | (4*) | (5*) | (6*) | (6*) | (5.6*) | (0.4*) |
| alkoxylate | | | | | | | | | | |
| FAAO 3) | | | | | | | | | | |
| C12/14 alkyl | 8 | 4 | 2 | 8 | 4 | 2 | — | — | 0.8 | 11.2 |
| polyglucose | (4*) | (2*) | (1*) | (4*) | (2*) | (1*) | | | (0.4*) | (5.6*) |
| APG 4) | | | | | | | | | | |
| Ratio | 1:2 | 2:1 | 5:1 | 1:2 | 2:1 | 5:1 | — | — | 14:1 | 1:14 |
| FAAO/APG - | | | | | | | | | | |
| based on | | | | | | | | | | |
| active | | | | | | | | | | |
| substance | | | | | | | | | | |
| (*) | | | | | | | | | | |
| Palm kernel | 2 | 2 | 2 | 2 | 2 | 2 | 2 | 2 | 2 | 2 |
| fatty acid | | | | | | | | | | |
| sodium salt | | | | | | | | | | |
| Sodium | ad 100 | | | | | | | | | |
| sulfate | | | | | | | | | | |
| Sodium | 4 | 4 | 4 | 4 | 4 | 4 | 4 | 4 | 4 | 4 |
| silicate | | | | | | | | | | |
| Sodium | 15 | 15 | 15 | 15 | 15 | 15 | 15 | 15 | 15 | 15 |
| percarbonate | | | | | | | | | | |
| Disintegrant | 6 | 6 | 6 | 6 | 6 | 6 | 6 | 6 | 6 | 6 |
| STPP | 20 | 20 | 20 | 20 | 20 | 20 | 20 | 20 | 20 | 20 |
| Polycarboxylate | 4 | 4 | 4 | 5 | 5 | 5 | 4 | 5 | 4 | 4 |
| TAED | 2 | 2 | 2 | 2 | 2 | 2 | 2 | 2 | 2 | 2 |
| Defoamer | 6 | 6 | 6 | 5 | 5 | 5 | 6 | 5 | 6 | 6 |
| Sodium | 7 | 7 | 7 | 8 | 8 | 8 | 7 | 8 | 7 | 7 |
| carbonate | | | | | | | | | | |
| Disintegration | <10 | 15 | 40 | <10 | 15 | 45 | 55 | 60 | 55 | 77 |
| time [s] | | | | | | | | | | |
| (30 N - 33 N, 5) | | | | | | | | | | |
| Disintegration | <10 | 15 | 50 | 15 | 20 | 60 | 70 | >100 | 75 | >100 |
| time [s] | | | | | | | | | | |
| (40 N - 44 N, 5) | | | | | | | | | | |
| Disintegration | 10 | 20 | 70 | 15 | 25 | 100 | 85 | >100 | 85 | >100 |
| time [s] | | | | | | | | | | |
| (50 N - 55 N, 5) | | | | | | | | | | |

1) contains 95% anionic surfactant; Sulfopon 1218 G
2) contains 70% LAS (linear alkylbenzenesulfonate), Maranil 2 G
3) C_{12/18} coconut fatty alcohol + 7E0, Dehydol LT 7
4) contains 50% nonionic surfactant; Glucopon 50 G
5) fracture hardness [N]

What is claimed is:

1. A laundry detergent or cleaning product tablet comprising compacted particulate laundry detergent and cleaning product, comprising surfactants and also, where appropriate, further laundry detergent and cleaning product ingredients, wherein the tablet comprises surfactants from the group consisting of fatty alcohol alkoxylates and alkyl polyglycosides in a ratio of from 10:1 to 1:10, preferably from 5:1 to 1:5, in particular from 2:1 to 1:2, based on the active substance content.

2. The laundry detergent or cleaning product tablet as claimed in claim 1, comprising fatty alcohol alkoxylates of the formula (I)
R¹O(CH₂CH₂O)ₙ[CH₂(CH₃)CHO]ₘH (I)
in which R¹ is an alkyl and/or alkylene radical having from 8 to 22 carbon atoms, n is a number from 1 to 40, preferably from 1 to 30, in particular from 1 to 15, and m is 0 or a number from 1 to 10.

3. The laundry detergent or cleaning product tablet as claimed in claim 1 and/or 2, comprising alkyl and/or alkenyl oligoglycosides of the formula (III)
R³O[G]ₚ (III)
in which R³ is an alkyl and/or alkenyl radical having from 4 to 22 carbon atoms, G is a sugar radical having 5 or 6 carbon atoms, and p stands for numbers from 1 to 10.

4. The laundry detergent or cleaning product tablet as claimed in any of claims 1 to 3, containing from 0.5 to 25% by weight, preferably from 1 to 15% by weight, in particular from 1 to 10% by weight, of alkyl and/or alkenyl oligoglycosides, calculated as active substance based on the tablet.

5. The laundry detergent or cleaning product tablet as claimed in any of claims 1 to 4, comprising further nonionic surfactants selected from the group formed by hydroxy mixed ethers, fatty acid lower alkyl esters, and amine oxides.

6. The laundry detergent or cleaning product tablet as claimed in any of claims 1 to 5, comprising anionic surfactants selected from the group formed by alkyl and/or alkenyl sulfates, alkyl ether sulfates, alkylbenzenesulfonates, soaps, monoglyceride (ether) sulfates, and alkanesulfonates.

7. The laundry detergent or cleaning product tablet as claimed in any of claims 1 to 6, comprising cationic, amphoteric or zwitterionic surfactants selected from the group formed by esterquats, alkyl betaines, amidoamine betaines and imidazolinium betaines.

8. The laundry detergent or cleaning product tablet as claimed in any of claims 1 to 7, comprising a cellulose-based disintegration aid.

9. The laundry detergent or cleaning product tablet as claimed in any of claims 1 to 8, comprising as further ingredients one or more auxiliaries and additives from the group of builders, optical brighteners, enzymes, enzyme stabilizers, defoamers, codisintegrants, proteins and protein derivatives, neutral filling salts, and dyes and fragrances.
